(19) United States
(12) Patent Application Publication
(10) Pub. No.: US 2007/0220423 A1
(43) Pub. Date: Sep. 20, 2007

(54) Page Builder System and Method

(75) Inventors: Daniel J. Charbonneau, Chanhassen, MN (US); Michael D. Schnapf, Eden Prairie, MN (US)

Correspondence Address: NORTH OAKS PATENT AGENCY, 45 ISLAND ROAD, NORTH OAKS, MN, 55127, US

(73) Assignee: DIGITAL RIVER, INC., Eden Prairie, MN (US)

(21) Appl. No.: 11/686,858

(22) Filed: Mar. 15, 2007

Related U.S. Application Data
(60) Provisional application No. 60/782,773, filed on Mar. 15, 2006.

(51) Int. Cl. G06F 17/00

(52) U.S. Cl. 715/517; 715/513; 715/530; 715/525

(57) ABSTRACT

Page builder system and method utilizes a user interface to maintain web pages. In accordance with a preferred embodiment, a user may change and maintain layouts, content, and page details simultaneously with little or no approval from a system administrator. Furthermore, a user may create layouts and content that may be reused for other pages and on other sites. Markup language is also allowed that will pull site specific content into the page based upon a site identification code in the URL, giving it cross site usability. In another preferred embodiment, a user has the ability to track change and pages in a system. Also, a user may confirm the deployment of a change before making a page active. A user may update web pages over a real time network. Finally, page builder system and method lists search results for faster load times.

This application claims the benefit of U.S. Provisional Application No. 60/782,773 filed 15 Mar. 2006, entitled “Page Builder,” which is incorporated herein by reference.

### FIELD OF THE INVENTION

The present invention relates to a web page user interface. In particular, it relates to updating web pages in real-time over a network.

### BACKGROUND OF THE INVENTION

The World Wide Web (web) has rapidly become an invaluable tool to individuals and businesses. Not only can an individual or business post information on the web, but they can also use the web to transact business. Because the public is acutely aware of the web's business and personal benefits, millions of web pages are being added to the web each year.

Typically, a web page is defined by a document containing Hyper Text Markup Language (HTML) code. An HTML document suitable for posting on the internet includes both “content” and “markup.” The content is information which describes a web page's text or other information for display or playback on a computer's monitor, speakers, etc. The markup is information which describes the web page's behavioral characteristics, such as how the content is displayed and how other information can be accessed via the web page.

In order to provide web-based information and services over the internet, the web employs “client” computers, “browser” software, and “server” computers. A client computer is a computer used by an individual to connect to the internet and access web pages. A browser is a software application, located on a client computer, which requests, via the internet, a web page from a server computer. After receiving the web page, the browser displays the web page on the client computer's monitor. A server computer is a computer which stores web page information, retrieves that information in response to a browser's request, and sends the information, via the internet, to the client computer. Thus, after a web page is created, the page must be “posted” to a particular server computer which “hosts” the page, so that the page can be accessed over the internet.

In order to have one's web page hosted by a server, the individual must contract with an internet service provider (ISP) associated with the server. This contract specifies, among other things, the duration of the time that the ISP will host the page, and how much the individual will pay for that hosting service.

Even though the idea of having one's own web page is appealing, the average individual has little or no knowledge about how to create a web page. Particularly, the average individual does not know how to create an HTML document or to post that document to a server computer. Unless that individual is willing to learn how to create and post their own web page, that individual is faced with few options.

The most commonly used avenue for an individual to get his web page on the internet is to employ one of numerous companies to provide, for a fee, web page development services. After contacting such a company, the individual would meet with one of the company's web page designers to explain the individual's concept for his web page. The designer would then create the associated HTML document. After approval by the individual, the designer may provide the service of posting the web page to a server computer. The server computer typically is not associated with the web page development company. Thus, the individual must separately contract with an ISP associated with the server to host the web page.

Typically, this web page creation and posting process is time consuming and expensive, because it requires the individual and the designer to spend a significant amount of time together working on a particular web page design. In addition, the process is inefficient because the individual must work separately with a designer and an ISP. Currently some pre-defined layouts are available on the internet. However those do not allow a client the flexibility of changing layouts, content, and page details all together. What is needed, therefore, is a method for clients to maintain static HTML pages themselves, combining elements of layouts, content, and page development.

The present invention provides a solution to these needs and other problems, and offers other advantages over the prior art.

### BRIEF SUMMARY OF THE INVENTION

The present invention is related to a software system that solves the above-mentioned problems. Page builder system and method utilizes a user interface to maintain web pages. In accordance with a preferred embodiment, a user may change and maintain layouts, content, and page details simultaneously with little or no approval from a system administrator. Furthermore, a user may create layouts and content that may be reused for other pages and on other sites. Markup language is also allowed that will pull site specific content into the page based upon a site identification code in the URL, giving it cross site usability. In another preferred embodiment, a user has the ability to track change and pages in the system. Also, a user may confirm the deployment of a change before making a page active and may update web pages over a real time network. Finally, the page builder system and method lists search results for faster load times. These features enable easy, profitable engagement with clients and customers using their particular designs and edits along with a faster and more efficient way to make web pages active on the internet.

Additional advantages and features of the invention will be set forth in part in the description which follows, and in part, will become apparent to those skilled in the art upon examination of the following or may be learned by practice of the invention.

### BRIEF DESCRIPTION OF THE DRAWINGS

FIG. 1 shows an overview diagram of page builder system and method.

FIG. 2 describes a menu page in page builder system and method.

FIG. 3 illustrates an “Add a Layout” page.

FIG. 4 illustrates a “List Layout” page.

FIG. 5 illustrates a page to edit an existing layout.

FIG. 6 shows a “Confirm Layout Development” page.

FIG. 7 shows a “Confirm Layout Rollback” page.

FIG. 8 shows a page to add content.

FIG. 9 shows a “List Content Blocks” page.

FIG. 10 illustrates a page to update an existing content block.

FIG. 11 illustrates a “Confirm Content Deployment” page.

FIG. 12 describes a “Confirm Content Block Rollback” page.

FIG. 13 illustrates a screen to add a page.

FIG. 14 illustrates a screen of page lists.

FIG. 15 illustrates a window for page links.

FIG. 16 illustrates a screen to update an existing page.

FIG. 17 shows a “Confirm Page Deployment” page.

FIG. 18 shows a “Confirm Page Rollback” page.

### DETAILED DESCRIPTION

The ability to combine layout editing, page building, and content changes over a real time network is an important advantage over traditional methods of administrator approval and pre-defined aspects. As will be evident to one of ordinary skill in the art, the principles of this invention are applicable with other web page building systems and products. Page builder system and method utilizes a user interface to maintain web pages. In accordance with a preferred embodiment, a user may change and maintain layouts, content, and page details simultaneously with little or no approval from a system administrator. Furthermore, a user may create layouts and content that may be reused for other additional pages and on other sites. Markup language is also allowed that will pull site specific content into the page based upon a site identification code in the URL, giving it cross site usability. In another preferred embodiment, a user has the ability to track changes and pages in a system. Also, a user may confirm the deployment of a change before making a page active. A user may update web pages over a real time network. Finally, page builder system and method lists search results for faster load times.

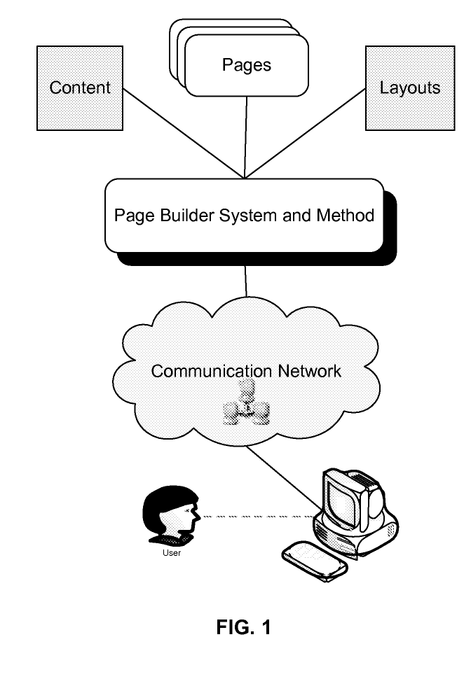

FIG. 1 illustrates an overview diagram of a page builder system and method. As shown, page builder operates over a communication network to upload pages, content, and layouts in real time. A user may edit and create new pages, content, and layouts as they see fit for their webpage. In a preferred embodiment, the page builder system and method is used to add, build, update and deploy static pages and their content. Also, it can be used to manage any type of static or splash landing pages.

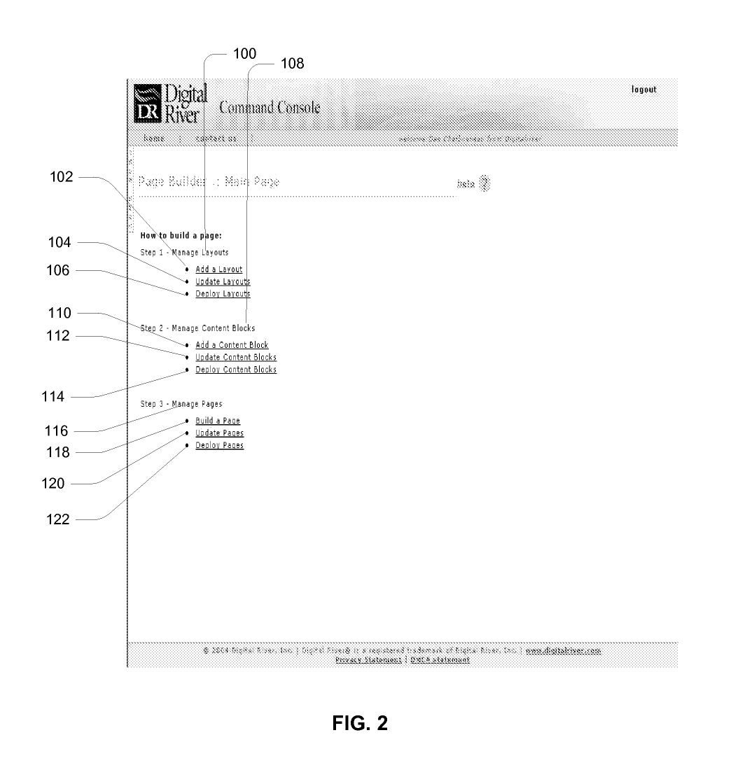

FIG. 2 describes a menu page in the page builder system and method. Under “Manage Layouts” 100, a user may “Add a Layout” 102, “Update a Layout” 104, and “Deploy Layouts” 106. To begin adding a new layout, the user will click on the “Add a Layout” 102 link. To update a current layout that is currently in design or deployment status, the user clicks the “Update Layout” 104 link. Moreover, to deploy a layout which is currently in design mode, the user clicks the “Deploy Layout” 106 link. In managing layouts (“Manage Layouts” 100), the user will lay out the framework of a page such as a header, footer and gutter. It will be understood by one of ordinary skill in the art that these are items on the page that will remain constantly static.

Referring again to FIG. 2, a user may also “Manage Content Blocks” 108. A user may “Add a Content Block” 110, “Update Content Blocks” 112, and “Deploy Content Blocks” 114. To begin adding a new content block the user will click on the “Add a Content Block” 110 link. To update a current content block that is currently in design or deployment status, the user will click on the “Update Content Blocks” 112 link. Moreover, to deploy a content block which is currently in design mode, the user will click on the “Deploy Content Blocks” 114 link. In managing content blocks 108, the user will be adding the content of the page. These items will be utilized in the body of the page. It will be understood that FIG. 2 is a navigational menu page for the user.

Under “Manage pages” 116, the user may “Build a Page” 118, “Update a Page” 120, and “Deploy Pages” 122. The final step will be assigning layouts and content blocks to one another. To build a new page by associating a layout and content block together, the user will click on the “Build a Page” 118 link. To update a current page currently in design or deployed status the user will click on the “Updated Pages” 120 link. Moreover, to deploy a page currently in the design mode the user will click on the “Deploy Pages” 122 link. In this final step, the user will be able to view a newly created page before deploying the finished page as well as receiving the link to the new static page. In a preferred embodiment of page builder system and method, all three steps of managing layouts, content, and pages should be completed in order to achieve a successful web page. However, it will be understood that this is not necessary and the user may tweak these steps as needed. Also, a user may return to this page at any time throughout the process of building a page.

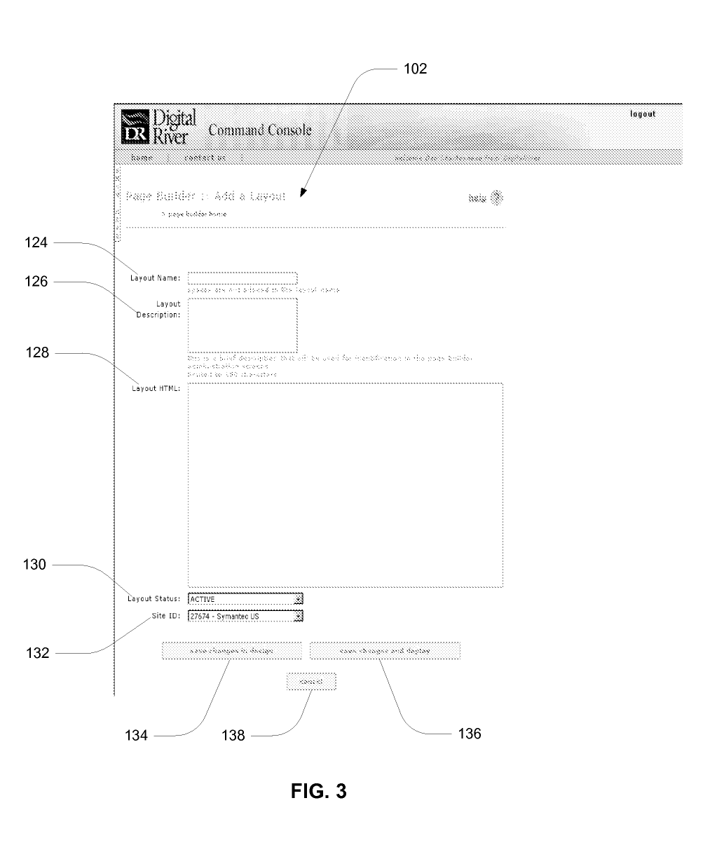

Referring now to FIG. 3, the “Add a Layout” 102 page is illustrated. The user may type a “Layout Name” 124 in the box provided. This name will be associated with a new layout. The same layout may be used with many different content blocks. In a preferred embodiment of page builder system and method a descriptive name is ideal. A descriptive and detailed name will allow the differentiation of layouts as more are added. Next, the user may type a “Layout Description” 126. “Layout Description” 126 is a brief description that will be used to identify a particular layout when viewing various layouts in the page builder system and method administrative screens. It will be understood that the maximum number of characters allowed is 150. Furthermore, in a “Layout HTML” 128 section HTML may be added for framework of a page. For example, a user may enter the HTML for a header, footer, and gutter if these are items that will remain constant throughout static pages. It will be understood that the user may specify the beginning of content with a [$Page, Body/] tag. There are other acceptable tags. For example, [$Site.MasterID/] dynamically pulls and returns the site identification (id). Moreover, [$Page.Header/] pulls and returns commerce headers and [$Page.Gutter/] pulls and returns commerce gutters. Finally, [$Page.Footer/] pulls and returns commerce footers and [$Page.ImagePath/] returns the path to page builder system and method images.

FIG. 3 also shows a “Layout Status” 130 section. The user may select “active” for a layout which can be used. “Active” status is more likely when the layout is new. Accordingly, selecting a “Retired” status means the layout cannot be used. “Retired” status will be used most often when updating older layouts that are not currently in use.

A “Site ID” 132 in FIG. 3 is selected from a dropdown list. The “Site ID” 132 controls the security to allow the ability to view, manage and have access to edit this layout. It will be understood that this in not necessarily the site id on which the layout appears. If the user wishes to retain changes in the design but not make the layout active they would select “Save Changes in Design” 134. Conversely, “Save Changes and Deploy” 136 would save changes and make the layout active. Finally, if the user does not wish to save the changes and start over, they may click “Cancel” 138.

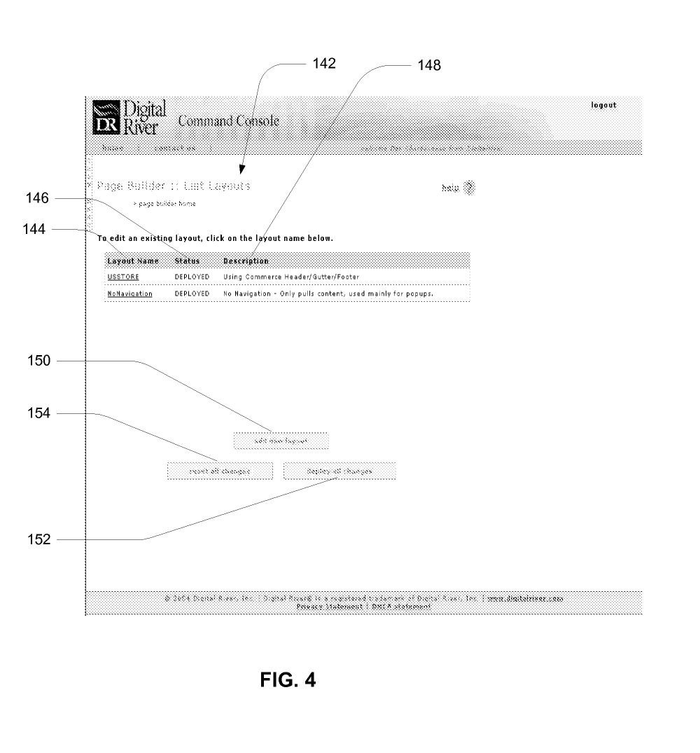

In a preferred embodiment of page builder system and method, a list of current layouts is listed along with the current status and description. FIG. 4 illustrates a “List Layout” 142 page. A status 146 of a layout can either be “deployed” or “in design.” The description 148 provided is the description entered in FIG. 3, “Layout Description” 126 and “Layout Name” 124. To modify a layout, the user clicks on a name 144 of the layout they wish to modify. Also, to add a new layout the user clicks on “Add New Layout” 150. Clicking on “Reset all Changes” 154 removes all changes made to all layouts listed and restores to a previous version. If there is no previous version, the new layout will be deleted. Clicking on “Deploy all Changes” 152 makes all changes live for all modifications made to the layouts listed.

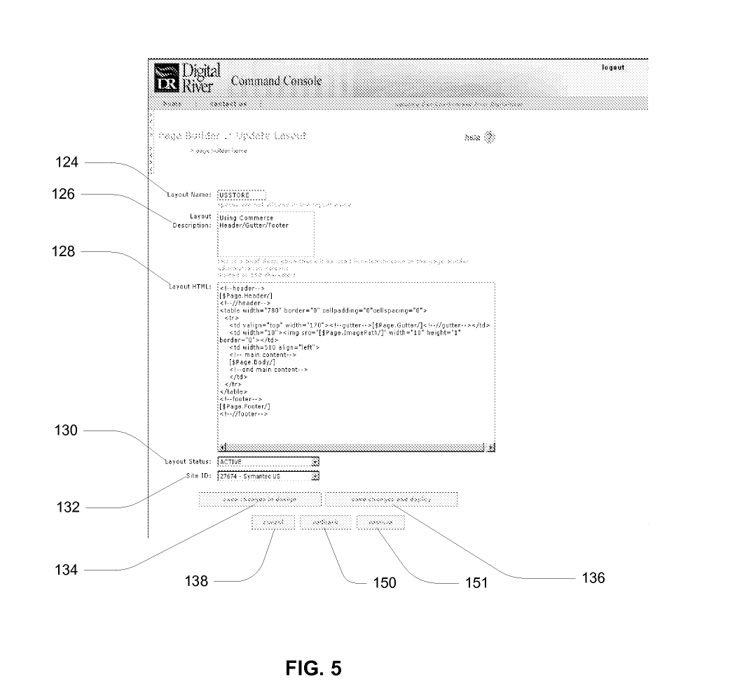

FIG. 5 shows a page to edit an existing layout. The user can make modifications to the “Layout Name” 124 and “Layout Description” 126 (described in FIG. 3). “Layout HTML” 128, “Layout Status” 130, and “Site ID” 132 can also be modified as the user sees fit (also described in FIG. 3). If the user wishes to retain changes in the design but not make the layout active they would select “Save Changes in Design” 134. Conversely, “Save Changes and Deploy” 136 would save changes and make the layout active. If the user does not wish to save the changes and start over, they may click “Cancel” 138. “Rollback” 150 reverts to the previously live version and takes the current version to a design mode, or staging mode. “Restore” 151 resets the design or staging mode to what is currently live.

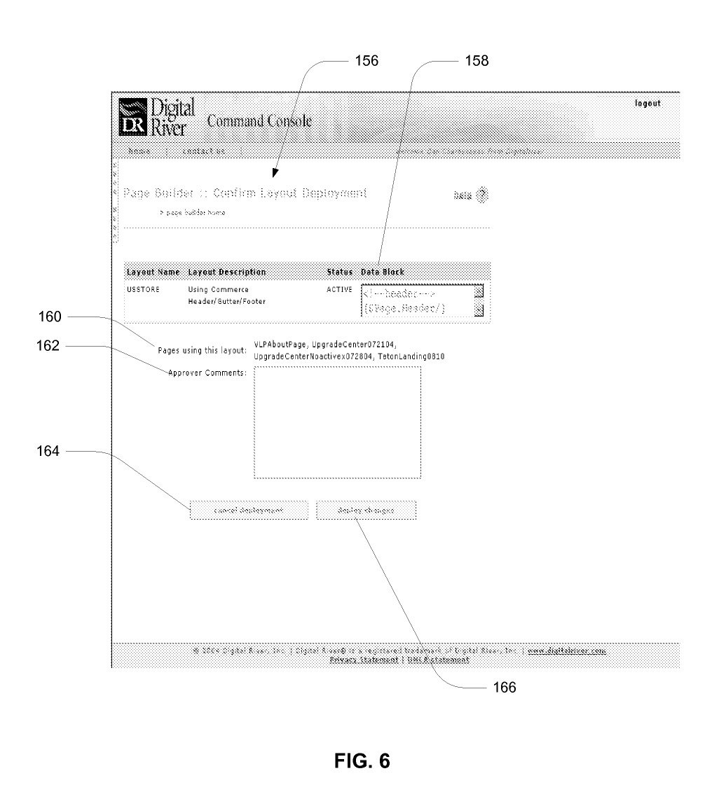

In a preferred embodiment of page builder system and method, a user may confirm the deployment of a page, layout, or content. This accomplishes two acts simultaneously. First, confirmation allows tracking of what is to be deployed. Second, confirmation allows for a review or second look at what the user has inputted. FIG. 6 shows a “Confirm Layout Deployment” 156 page. Here, a record of the layouts which have modifications are listed along with the layout description, status, and part of data blocks (see also FIG. 3). A “Data Block” 158 shows the user what they are about to active status. “Pages using this layout” 160 are noted to aid the user in identifying where and how the layouts are currently used. Furthermore, the user may enter any comments in an “Approver Comments” 162 section regarding the changes. The “Approver Comments” 162 section is not obligatory. Next, clicking “Cancel Deployment” 164 abandons the changes listed in the layouts. Conversely, clicking “Deploy all Changes” 166 completes the changes as made.

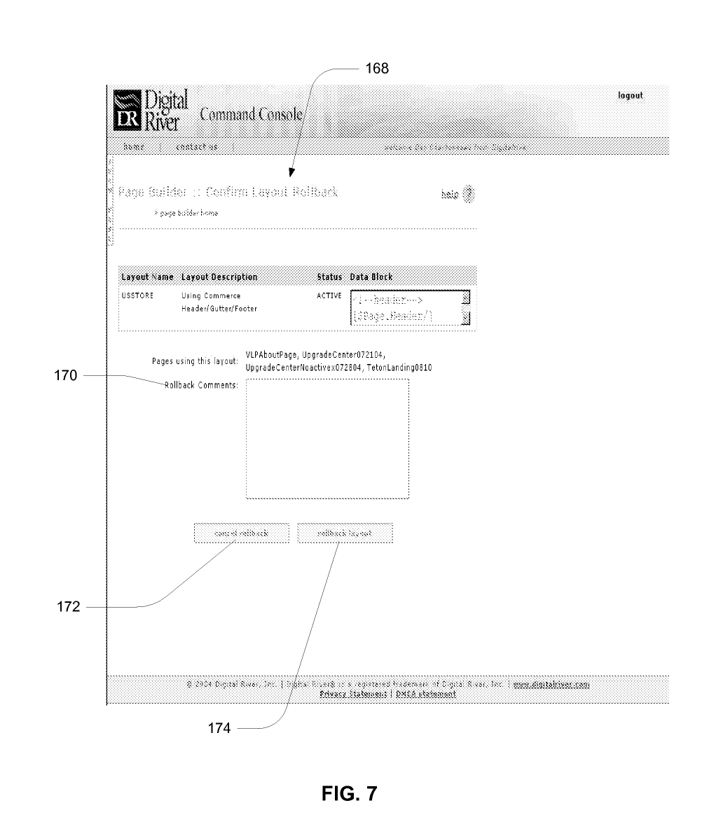

Referring to FIG. 7, a “Confirm Layout Rollback” 168 page is described. A record of the layouts which have modifications to be rolled back are listed along with the layout description, status, and part of data blocks (see also FIG. 3). Again, the status of a layout may be active or retired. Under a “Rollback Comments” 170 section the user may enter any comments regarding rollback. Clicking “Cancel Rollback” 172 abandons the changes and clicking “Rollback Layout” 174 completes the changes and returns to a list of the layouts after rollback is completed. The user may continue to rollback to previous versions until they have gone back to the beginning when the layout did not exist.

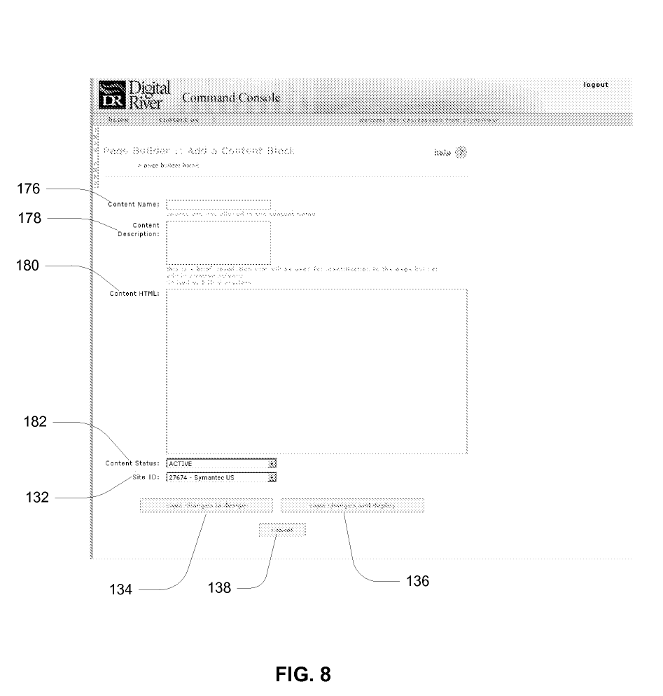

FIG. 8 shows a page to add content. The user may type a “Content Name” 176. This is the name that will be associated with new content. A detailed and descriptive name aids in differentiating contents as more are added. “Content Description” 178 is a brief description that will be used to identify this particular content when viewing different content in the page builder system and method administration screens. It will be understood that the maximum number of characters allowed is 150. Next, the user may enter “Content HTML” 182 for the body of the page. This is the part of the page that will replace the body tag in the layout. For example, an acceptable tag to utilize in this content area is [$Site.MasterID/], which dynamically pulls and returns the site id. Also, [$Page.ImagePath/] returns the image path for a page builder system and method image. Markup language is also allowed that will pull site specific content into the page based upon a site identification code in the URL, giving it cross site usability.

Referring again to FIG. 8, next a user selects a “Content Status” 182. “Content Status” 182 can either be “active” for content that can be displayed and used or “retired” for content that may not be displayed and used. “Retired” status is often chosen when updating content that is inactive. It will be understood by one of ordinary skill in the art that “active” and “retired” are chosen from a drop down menu style. A drop down menu is a menu whose title is normally visible but whose contents are shown only when the user activates it, normally by clicking on the title or a small arrow next to the title, whereupon the menu items appear below the title. The user may select an item from the menu by dragging the mouse from the menu title to the item and releasing, or by clicking the title and then clicking the item. It will further be understood that drop down menus are used in various aspects of the page builder system and method.

Next, the user will select a “Site ID” 132 from a drop down list. The “Site ID” 132 selects which sites will have the ability to view, manage and have access to edit this content. This in not necessarily the id on which the content appears. Finally, if the user wishes to retain changes in the design but not make the design active, they should click on “Save Changes in Design” 134. Conversely, the user should click “Save changes and Deploy” 136 if they wish to save and make changes active. Clicking “Cancel” 138 will abandon any changes and start the process of building content over.

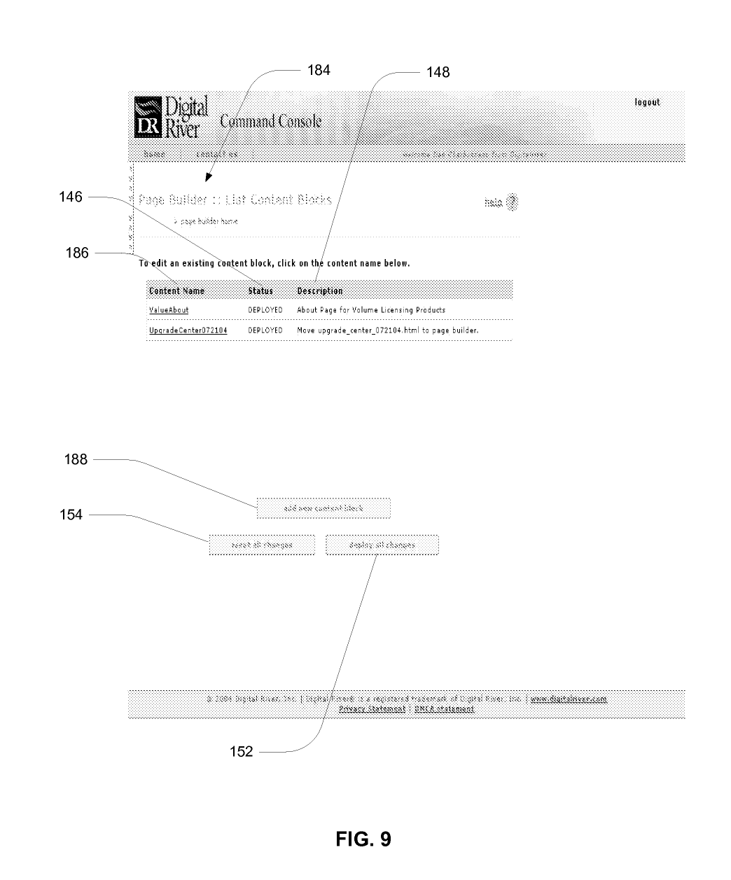

FIG. 9 describes a “List Content Blocks” 184 page. Here, a record of the current content blocks is listed along with the current status 146 and description 148. Similar to layout lists in FIG. 4, the status of the content block can either be “deployed” or “in design.” The description 148 provided is the description entered in the content block description section (see FIG. 8). To modify a content block, the user should click on the applicable part under “Content Name” 186. Furthermore, the user should click on “Add New Content Block” 188 to insert new content. Clicking on “Reset all Changes” 154 removes all changes made to all content listed and restores to a previous version. If there is no previous version, the new content will be deleted. Clicking on “Deploy all Changes” 152 makes all changes live for all modifications made to the content blocks listed.

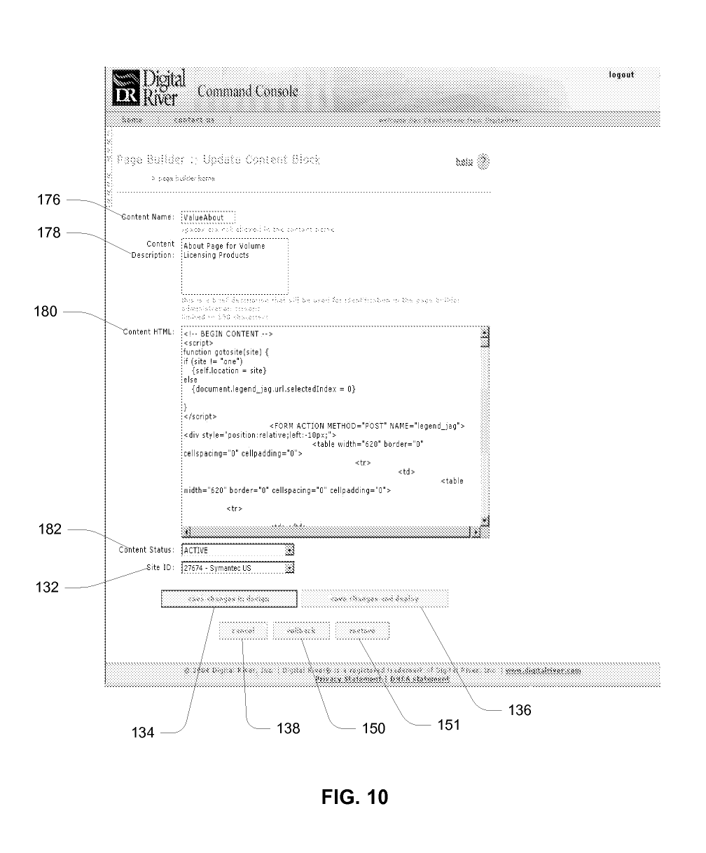

In another preferred embodiment of page builder system and method, a user may update content blocks. FIG. 10 illustrates a page to update an existing content block. The user may make modifications to the “Content Name” 176, “Content Description” 178, “Content HTML” 180, “Content Status” 182, and “Site ID” 132 sections (see FIG. 8). If the user wishes to retain changes in the design but not make the content active they may select “Save Changes in Design” 134. Conversely, “Save Changes and Deploy” 136 will save changes and make the content active. If the user does not wish to save the changes and start over, they may click “Cancel” 138. “Rollback” 150 reverts to the previously live version and takes the current version to a design or staging mode. “Restore” 151 resets the design or staging mode to what is currently live.

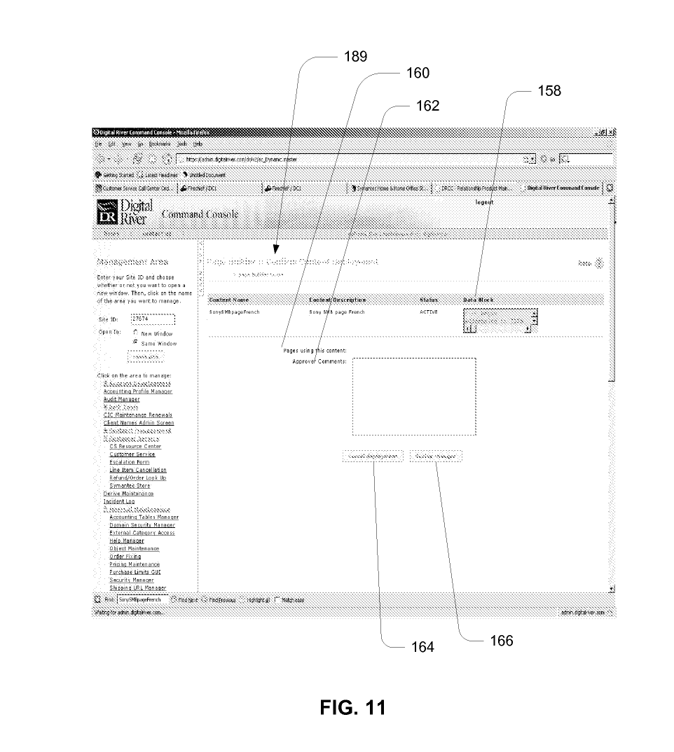

Referring now to FIG. 11, a “Confirm Content Deployment” 189 page is shown. Here, a record of the contents which have modifications are listed along with content block description, status and part of the data block (see also FIG. 3). A “Data Block” 158 shows the user what they are about to change to active status. “Pages using this layout” 160 are noted to aid the user in identifying where and how the layouts are currently used. Furthermore, the user may enter any comments in an “Approver Comments” 162 section regarding the changes. The “Approver Comments” 162 section is not obligatory. Next, clicking “Cancel Deployment” 164 abandons the changes listed in the layouts. Conversely, clicking “Deploy all Changes” 166 completes the changes as made.

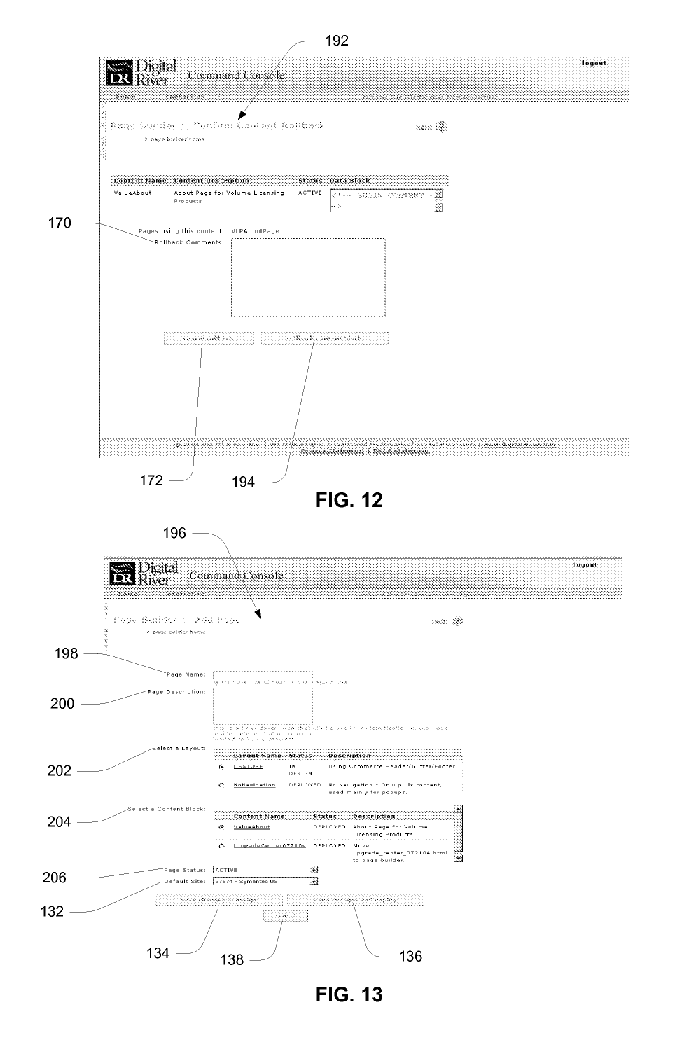

FIG. 12 illustrates a “Confirm Content Block Rollback” 192 page. Records of the content blocks which have modifications to be rolled back are listed along with the content description, status, and part of data block (see also FIG. 3). As mentioned for layouts, the status of a content block may be “active” or “retired.” Under the “Rollback Comments” 170 section the user may enter any comments regarding rollback. Clicking “Cancel Rollback” 172 abandons the changes and clicking “Rollback Content Block” 194 completes the changes and returns to a list of the content blocks after rollback is completed. The user may continue to rollback to previous versions until they have gone back to the beginning when the content did not exist.

In a preferred embodiment of page builder system and method, a user may add a page to their site. FIG. 13 illustrates an “Add Page” screen 196. A user may add a “Page Name” 198. This is the name that will be associated with a new page. Descriptive and unique names aid in differentiating various pages. A “Page Description” 200 identifies this particular page when viewing different pages in various page builder system and method administration screens. It will be understood that the maximum number of characters allowed is 150. Next, the user will “Select a Layout” 202. This layout, which has been previously set, will be used as a framework for the new page. It will be understood by one of ordinary skill in the art that a layout can be chosen by selecting an appropriate radio button corresponding to a layout name.

Referring again to FIG. 13, the user chooses a content block in the “Select a Content Block” 204 section. The content block, which has been previously set, is used for the new page as the body. Again, the user may select the appropriate radio button near a content name. A “Page Status” 206 section is also located in the “Add Page” 196 screen. Here, the user may select a “Retired” or “Active” status. Selecting the “Retired” status means the page cannot be used. In the alternative, selecting the “Active” status means the page will be used or displayed on a site. Finally, the user selects a “Site ID” 132 from a drop down list. This is the id of sites that will have the ability to view, manage, and have access to edit the page, not necessarily the site id on which the page appears. If the user wishes to retain changes in the design but not make the design active, they should click on “Save Changes in Design” 134. Conversely, the user should click “Save changes and Deploy” 136 if they wish to save and make changes active. Clicking “Cancel” 138 will abandon any changes and start the process of building a page over.

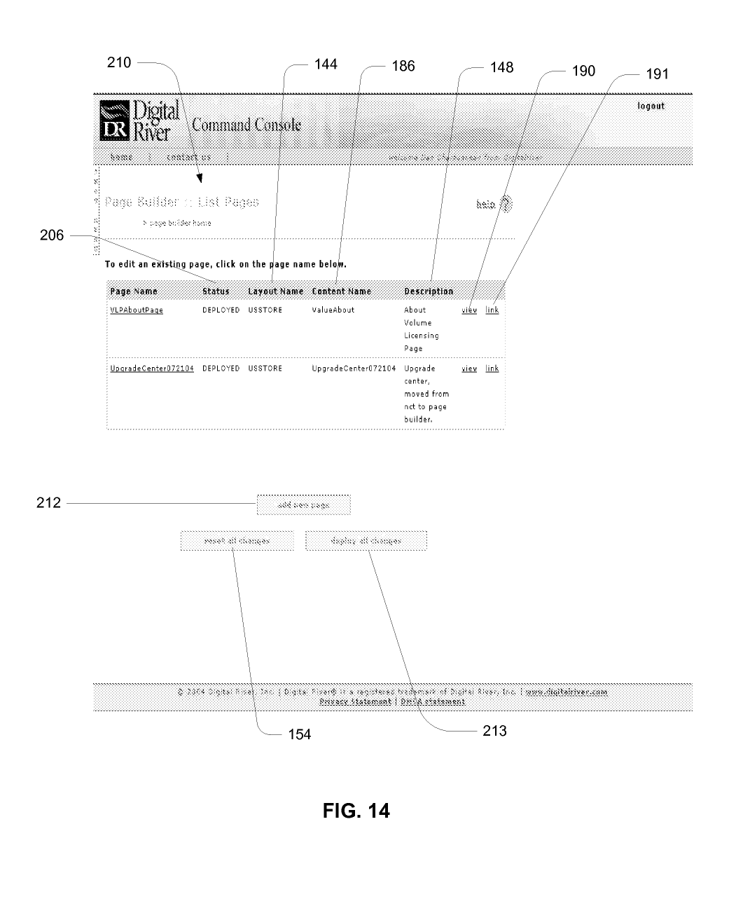

FIG. 14 illustrates a screen of page lists 210 in page builder system and method. Here, a record of the current pages is listed along with the page status 206, layout name 144, content name 186, and description 148. By clicking “View” 190, a user may view a particular page which has been built. A new window will open displaying the page. Moreover, clicking on “Link” 191 will allow the user to view a link address to the corresponding page. A new window will open displaying the link address. It will be understood that the link address can be copied by simultaneously clicking on “Link” 191 and pressing “CTRL” and “C” on a keyboard. Thus a user may paste the link address wherever they would like to link to the page. To input a site id for any dynamic links which may have been used in a content block HTML section, the user may click on a link on the line of the page they wish to enter the sit id for dynamic links. This is the site id that was entered wherever [$SITE.ID/] was on content page HTML.

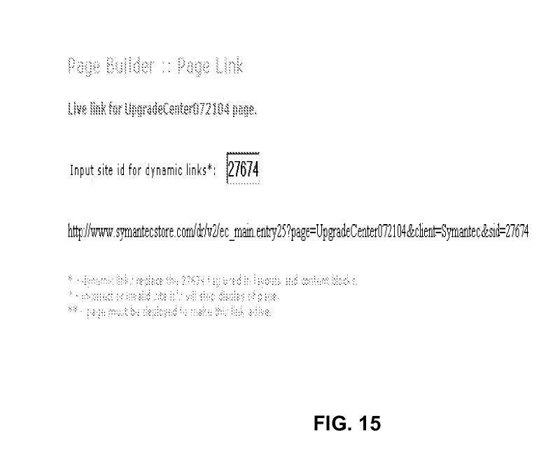

Referring to FIG. 14 further, clicking on “Add New page” 212 will add a new layout. Clicking on “Reset all changes” 154 will remove all changes made to all pages listed and restore to a previous version. If there are no previous versions and are resetting to a page just entered, the new page will be deleted. Also, clicking on “Deploy All Changes” 213 makes all changes live for all modifications made to listed pages. After clicking on “Link” 191 in FIG. 14 the user will be taken to a window for page links, shown in FIG. 15.

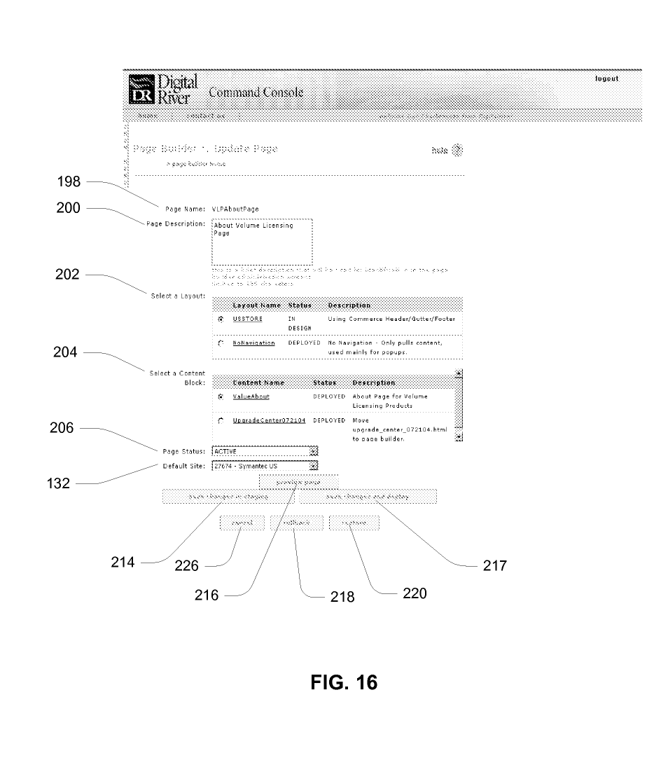

In a preferred embodiment of page builder system and method, the user may update an existing page. FIG. 16 illustrates a screen to update an existing page. The user may make modifications to the “Page Name” 198, “Page Description” 200, “Select a Layout” 202, “Select a Content Block” 204, “Page Status” 206 and “Site ID” 132 sections. The user may click “Preview Page” 216 to foretaste a page. Moreover, clicking “Save Changes in Staging” 214 saves the changes but does make the changes active. Conversely, “Save Changes and Deploy” 217 saves and makes changes active. If the user does not wish to save the changes and start over, they may click “Cancel” 226. “Rollback” 218 reverts to the previously live version and takes the current version to a design or staging mode. “Restore” 220 resets the design or staging mode to what is currently live.

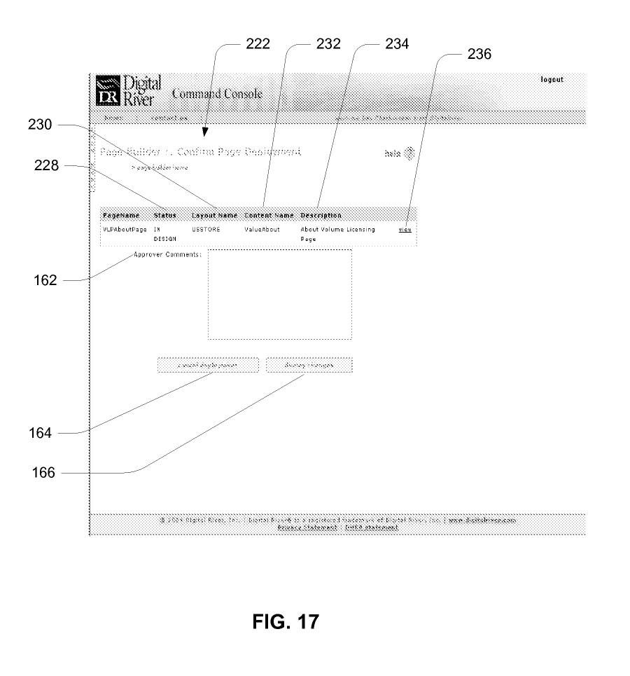

FIG. 17 shows a “Confirm Page Deployment” 222 page. Here, a record of the pages which have modifications to be deployed are listed along with the “Status” 228, “Layout Name” 230, “Content Name” 232, and “Description” 234. To foretaste the page before deploying, a user may click on “View” 236. A new window will open displaying the page. Furthermore, the user may enter any comments in an “Approver Comments” 162 section regarding the changes. The “Approver Comments” 162 section is not obligatory. Next, clicking “Cancel Deployment” 164 abandons the changes listed in the layouts. Conversely, clicking “Deploy all Changes” 166 completes the changes as made.

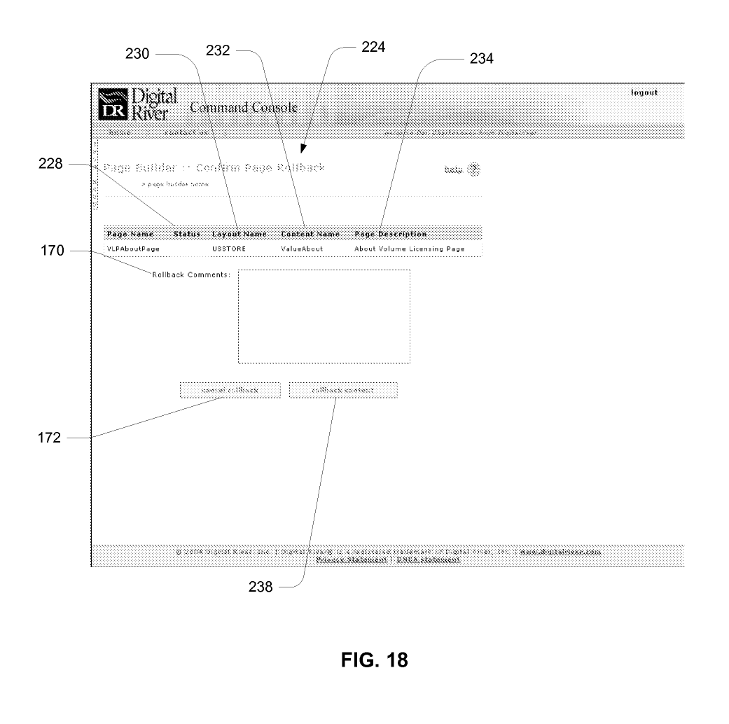

Referring to FIG. 18, a “Confirm Page Rollback” 224 page is described. Here, a record of the pages which have modifications to be deployed are listed along with the “Status” 228, “Layout Name” 230, “Content Name” 232, and “Description” 234. Under a “Rollback Comments” 170 section the user may enter any comments regarding rollback. Clicking “Cancel Rollback” 172 abandons the changes and clicking “Rollback Content” 238 completes the changes and returns to a list of the layouts after rollback is completed. The user may continue to rollback to previous versions until they have gone back to the beginning when the layout did not exist. Thus, a user has the ability to track changes and pages as they build and edit them. In this manner, a user may create layouts and content that may be reused for other additional pages and on other sites. A user may update web pages over a real time network. Finally, page builder system and method lists search results for faster load times.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the web interface such that different dialog boxes are presented to a user that are organized or designed differently while maintaining substantially the same functionality without departing from the scope and spirit of the present invention.

What is claimed is:

1. A web-based page builder system for use on a network, comprising:
a layout module for designing web page layouts defining web page elements for a particular web site based on user input;
a content editor module for applying a layout to a web page and modifying content of the web page for the particular web site based on user input;
a page organization module for determining organization of pages in the particular web site based on user input; and
a deployment module for publishing pages for the particular web site to the web server.

2. The web-based page builder system of claim 1 wherein the layout module is configured to enable reusing layouts from those previously created for other web sites by identifying a layout from another web site.

3. The web-based page builder system of claim 1 wherein the content editor module is configured to enable reusing content from those previously created for other web sites by identifying content from another web site.

4. The web-based page builder system of claim 1 further comprising a version tracking module configured to track changes in either the layouts or content.

5. The web-based page builder system of claim 4 further comprising a rollback module configured to enable reverting a layout to a previously version of the layout as tracked by the version tracking module.

6. The web-based page builder system of claim 4 further comprising a rollback module configured to enable reverting content to a previously version of the content as tracked by the version tracking module.

7. The web-based page builder system of claim 4 wherein the version tracking module comprises a status designation in either the layouts or content.

8. The web-based page builder system of claim 7 wherein a layout or content is designated for live use on the particular web site when the status designation is active.

9. The web-based page builder system of claim 7 wherein a layout or content is not designated for live use on the particular web site when the status designation is retired.

10. The web-based page builder system of claim 1 wherein the layout module is configured to permit designing a layout by utilizing a previously saved layout.

11. A web-based page builder method for use on a network, comprising steps of:
designing web page layouts that define web page elements for a particular web site based on user input;
applying a layout to a web page based on user input;
modifying content of the web page for the particular web site based on user input;
determining organization of pages in the particular web site based on user input; and
publishing pages for the particular web site to the web server.

12. The method of claim 11 wherein the designing step comprises reusing layouts from those previously created for other web sites by identifying a layout from another web site.

13. The method of claim 11 wherein modifying step comprises reusing content from those previously created for other web sites by identifying content from another web site.

14. The method of claim 11 further comprising a step of tracking changes in either the layouts or content.

15. The method of claim 14 further comprising a step of reverting a layout to a previously version of the layout as tracked in the tracking step.

16. The method of claim 14 further comprising a step of reverting content to a previously version of the content as tracked in the tracking step.

17. The method of claim 14 wherein the tracking step comprises tracking a status designation in either the layouts or content.

18. The method of claim 17 further comprising a step of designating a layout or content for live use on the particular web site when the status designation is active.

19. The method of claim 17 a step of designating a layout or content as not for live use on the particular web site when the status designation is retired.

20. The method of claim 11 wherein the designing step comprises designing a layout by utilizing a previously saved layout.
